(19) United States
(12) Patent Application Publication
(10) Pub. No.: US 2002/0156799 A1
(43) Pub. Date: Oct. 24, 2002

(54) System and method for verifying and correcting websites

(76) Inventors: Stephen Markel, Ann Arbor, MI (US); Tom Brinck, Ann Arbor, MI (US); Brian Minnebo, Wixom, MI (US); Ali Hakim, Ann Arbor, MI (US); Derren Hermann, Ann Arbor, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/128,850

(22) Filed: Apr. 24, 2002

Related U.S. Application Data
(60) Provisional application No. 60/286,087, filed on Apr. 24, 2001.

(51) Int. Cl. G06F 12/00

(52) U.S. Cl. 707/202; 707/513; 714/38

(57) ABSTRACT

A system 100 and method 102 for evaluating and correcting websites includes an assessment module 114 to parse and analyze the website as a function of a ruleset of design guidelines. A list of automatic correction items, semi-automated assisted correction items, and manual correction items is reported by a reporting module 116. The listed items are automatically, semi-automatically, or manually corrected by or through a correcting module 118. The system 100 and method 200 provide an internet based software tool to enable website providers to diagnose, evaluate, report, and retrofit code violations existing in websites.

### CROSS-REFERENCE TO RELATED APPLICATIONS

This application claims the benefit of U.S. Provisional Patent Application Serial No. 60/286,087, filed Apr. 24, 2001.

### FIELD OF THE INVENTION

The present invention relates generally to websites, and more particularly to a system and method for evaluating and correcting websites.

### BACKGROUND OF THE INVENTION

In the field of website design and branding, design standards such as usability and accessibility are essential for providing access to the vast amounts of information available over the internet. Compliance standards have been established by the federal government and international entities such as the World Wide Web Consortium (W3C). Currently, manual compliance processes, whereby a designer manually verifies that the website complies with a particular design standard, are inadequate. Automating this process improves the consistency and completeness of the website, while applying such processes manually is time consuming and cost-prohibitive. Moreover, applying the design standards as they change is quite difficult when manually verifying a website as a function of the design standard.

For example, in 1998, Congress amended the Rehabilitation Act (29 USC 794(d)) to require Federal agencies to make their electronic and information technology accessible to people with disabilities. Inaccessible technology interferes with an individual's ability to obtain and use information quickly and easily. Section 508 of the Rehabilitation Act was enacted to eliminate barriers in information technology, to make available new opportunities for people with disabilities, and to encourage development of technologies that will help achieve these goals. The law applies to all Federal agencies when they develop, procure, maintain, or use electronic and information technology. Under Section 508, agencies must give disabled employees and members of the public access to information that is comparable to the access available to others.

Just as computers vary by operating system, processor speed, screen size memory, and networking abilities, users vary in ways both expected and unexpected. Some differences that are more commonly thought of are language, gender, age, cultures, preferences, and interests. But some of the differences that need to be addressed more by the software and web development community are skills and impairments. Designing for diversity not only increases the number of people able to access software or a website but also increases the user's level of involvement with it. Barrier-free design is beneficial for all users. Designing for universal access is not only good social practice, but in general, it is good business practice.

One in five people in the United States has some kind of disability, and an estimated 30 million people are impacted by inaccessible computer and software design. The number of people with disabilities is only increasing, as it has increased 25% in the last decade, especially among those 50 years old and above. And among the 31 million seniors aged 65 and above, 16 million reported some level of disability. But accessibility actually affects a much larger percentage of the population, as many people who do not have permanent disabilities have temporary conditions that alter their abilities for a period of time. And beyond that, the very young and the very old can also benefit from more accessible design. With this in mind, accessibility in website design should really be thought of as part of universal design.

The internet has the potential to broaden the lives and increase the independence of people with disabilities. For people who can be physically as well as socially isolated, access to the internet can offer information, social interaction, cultural activities, employment opportunities, and consumer goods. However, statistics indicate not as many people with disabilities are able to take advantage of these possibilities, in large part because their needs have not been addressed by the web design community.

There are a wide variety of physical and mental disabilities that limit the individual's capacity to access and operate websites. While the constraints imposed by their disabilities can be overcome, most internet sites are inadequately equipped for people with special needs. According to the Americans with Disabilities Act, a person is considered to have a disability if he or she has a physical or mental impairment that substantially limits one or more of the following:

1. Major Life Activities:

. . . seeing

. . . hearing

. . . speaking

. . . lifting and carrying

. . . using stairs

. . . walking

2. Activities of Daily Living

. . . getting around inside the home

. . . getting in or out of a bed or chair

. . . bathing

. . . dressing

. . . eating

. . . toileting

3. Instrumental Activities of Daily Living

. . . going outside the home

. . . keeping track of money or bills

. . . preparing meals

. . . doing light housework

. . . using the telephone

This definition was created to determine non-discrimination and public assistance policies. But in terms of how accessibility affects those who use computers, the definition can be broadened to include children, whose mental and motor skills have not fully developed, those with temporary disabilities, and older people whose physical, mental, and motor skills may be temporarily or permanently affected to varying degrees of disability. And, even further, busy people, people with repetitive stress injuries, near or farsighted people not wearing corrective lenses, the colorblind, and international users are likely to appreciate attention given to accessibility.

Of the 20 million Americans age 15 and over with work disabilities, 2.3 million uses the internet either at home or elsewhere. This is a significant number of users whose needs are not being considered often enough as software and websites are designed. This oversight not only affects disabled users but also prevents many companies and agencies from reaching the audiences that may be most interested in their information and products. As the definition of “disabled” is broadened to include the groups mentioned above, it is clear that designing with accessibility in mind is really part of “universal” access.

Imperfect eyesight is the most serious web accessibility problem. Low-vision users require larger fonts and images, optimal contrast, and superior legibility. Sightless users must employ dedicated browsers, which can speak text or a Braille reader to access the web and consume information. Color-blind users require that color be used cautiously, and color distinctions be supplemented with redundant coding of information.

Limited physical capabilities are perhaps the second most common use inhibitors for website consumers. Motor-skill maladies such as arthritis or cerebral palsy have a severe impact on one's capacity to target buttons or links, type, operate multi-finger sequences, or execute duplicate key presses. Effective methods to improve the experiences of physically disadvantaged users include minimization of typing, reducing mouse interactions, enlarging target regions, and increasing the proximity between and size of buttons.

Dramatic cognitive problems may be difficult to significantly impact, however many targeted disorders, such as common congenital problems (e.g. attention deficit disorder) and accident or disease-related disorders (e.g. memory limitations), can be addressed. For example, simplifying the user interface, reducing memory load, moderating the need for planning, lessening decision-making, and using simpler language can address cognitive disorders.

There are a variety of common syndromes, such as dyslexia or speech impediments, that may also negatively impact site functionality. Reducing the linguistic complexity of the interface, increasing the legibility and readability of text, and removing the need for speech input can enable individuals faced with these types of disorders. International users will also benefit from reductions of a site's linguistic complexity.

Epileptic seizures can be triggered by exposure to rapidly blinking lights, repetitive motion, and repetitive sounds. Eliminating or changing the frequencies to which people are most vulnerable would be beneficial to those afflicted with these types of disorders.

Addressing accessibility issues provides benefits to all users, not just the disabled population. A variety of users are limited in their ability to perform certain actions, including the young, the elderly, those who are temporarily disabled, individuals with colorblindness or repetitive stress injuries, international users, those utilizing mobile devices, people who work in hands-free, low-light, and high-noise environments, and busy individuals. The need for improved accessibility clearly spans beyond users with disabilities, although this segment of the population is significant.

According to the US Bureau of the Census, 1 in 5 Americans (54 million) have some kind of disability and 1 in 10 has a severe disability. Inaccessible computer and software designs impact an estimated 30 million users in the United States. The number of people with disabilities is increasing (25% more today than a decade ago). On average, persons with disabilities have lower income, are older, and are less likely to be employed. However, demand is growing as more users join the online community.

As the American population matures, the number of disabilities will continue to grow. Disabilities increase with age. While individuals 50 and over make up only 27% of the total population, they account for more than half (63%) of the disabled population. Until recently, this age group has not been recognized as the second fastest growing group of internet users.

Many causes of the growing digital divide can be attributed to disabilities. People with a disability are only half as likely to access the internet as those without a disability (21% to 42%), 21% of people with a disability use a computer on a regular basis compared to 51% without disabilities. Most attempts to access the internet by disabled users have been unsuccessful. Overall, using computers and the internet is a frustrating experience. Barriers to the internet include expensive hardware and software, lack of training, concerns about fraud, invasion of privacy, and unreliable information, as well as poorly designed sites.

In 1996, the Department of Justice determined that the Americans with Disabilities Act applies to internet web pages. The Department of Justice is backing lawsuits filed across the country against websites that do not conform to Title II and Title III of the ADA. The Telecommunications Act of 1996 also includes legislation to enforce standards in converging technology, wireless communications, and emerging technology.

The legal ramifications are not the only reasons for compliance with accessibility standards, however. There are many markets that are interested in sites that conform to accessibility standards, such as: Government, Education, Libraries, News groups and online periodicals, Public utilities and transportation, Healthcare, and Financial Services.

The public sector is not the only area that benefits from more accessible websites. Any business that wants a larger market share should be interested in making their websites more accessible.

Many of the issues raised by advocates of accessibility are answered by the “universal access” approach. Universal access calls for developing products that accommodate the broadest range of users regardless of age or ability. It calls for design that is usable for all people without needing special alterations or adaptations for accessibility.

The benefits of universal access in websites extend beyond the elderly or disabled populations. Universal access also addresses many of the issues that arise in internationalization, which is becoming increasingly important in today's marketplace. Some of the key elements to universal access are: providing for interoperability with many applications, providing accessibility to the disabled; and providing customization and localization features for people from different countries and backgrounds.

The internet faces a recognizable usability crisis. The number of web pages being produced annually continues to grow at an exponential rate, and ease of use is an increasing concern. As end-user adoption of the Web continues to grow, most of the users coming online for the first-time are those who do not have substantial experience, and the demographic of these new users is broadening, so that fewer expectations of prior education, training, or cultural expectations can be assumed. More disturbing is that little attention has been focused on a socially relevant segment of the population—the disabled. It is imperative that all internet content publishers provide suitable access to the disabled for reasons of fundamental social fairness, legal liability, and shared equality.

Deployment of site designs to meet the stringent requirements of this special needs segment entails a variety of approaches, including: expensive training of designers, complex design processes, user needs analysis, user testing, utilization of specification and prototyping methods, integration of divergent design principles, and understanding the underlying cognitive psychology of the interaction. While web design principles are progressively developed and understood, their application requires training and time-consuming application. A vast majority of internet developers, content providers, and site maintenance organizations do not have the financial or human resources, or time required, to become proficient in the rules, methods, and solutions to design and develop access avenues for this special needs segment of the population.

The rapid growth of the internet and high adoption of the technology by all facets of our society is creating a new class of problems for disabled citizens. Two primary classes of internet consumers are being created, information empowered and information inhibited. An information gap is being created between these consumer groups as a result of government educational, community, and business sites not meeting the access requirements of the disabled. Information providers, across all vertical markets, are perpetuating the division and creating a climate of discrimination because of a lack of understanding, technical capabilities, and the cost associated with providing sites explicitly formulated to meet the design requirements which must be met to allow the disabled to use them. For reasons of social fairness, equal opportunity, and the potential for litigation, this condition must be corrected to afford every individual access to content on the internet.

Furthermore legislation, or case law applying existing regulations, may be forthcoming as the Americans with Disabilities Act is being applied to the internet in terms of the accessibility of websites. To date, lawsuits have been successfully filed in San Jose, Chicago, and Washington, D.C to enforce access of sites to people with disabilities. The Department of Justice is supporting the plaintiffs in these cases.

Accordingly, the present invention is aimed at solving one or more of the disadvantages set forth above.

### SUMMARY OF THE INVENTION AND ADVANTAGES

In one aspect of the present invention, a system to evaluate and correct websites is provided. The system includes a module to parse and analyze the website as a function of a ruleset of design guidelines. A list of automatic correction items, semi-automated assisted correction items, and manual correction items is reported by a reporting module. The listed items are automatically, semi-automatically, or manually corrected by or through a correcting module.

In another aspect of the present invention, a method to evaluate and correct websites is provided. The method parses and analyzes the website as a function of a ruleset of design guidelines. A list of at least one of automatic correction items, semi-automated assisted correction items, and manual correction items is reported and the listed items are automatically, semi-automatically, or manually corrected.

The primary goal of this tool is to provide an internet based software tool to enable website providers to diagnose, evaluate, report, and retrofit code violations existing in websites meet both in-house and industry design standards.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a block diagram of a system for evaluating and correcting a website, according to an embodiment of the present invention;

FIG. 2 is a flow diagram of a method for evaluating and correcting a website, according to an embodiment of the present invention;

FIG. 3 is a graphical representation of an initial screen of a graphical user interface, according to an embodiment of the present invention;

FIG. 4 is a graphical representation of a portion of a reporting screen of the system of FIG. 1, according to an embodiment of the present invention;

FIG. 5 is a graphical representation of another portion of the reporting screen of FIG. 4;

FIG. 6 is a graphical representation of a progress screen of the system of FIG. 1, according to an embodiment of the present invention;

FIG. 7 is a graphical representation of a summary report screen of the system of FIG. 1, according to an embodiment of the present invention;

FIG. 8 is a graphical representation of a standard screen of the system of FIG. 1, according to an embodiment of the present invention;

FIG. 9 is a graphical representation of a correction screen of the system of FIG. 1, according to an embodiment of the present invention;

FIG. 10 is a graphical representation of a tips screen of the system of FIG. 1, according to an embodiment of the present invention;

FIG. 11 is a graphical representation of a correction summary screen of the system of FIG. 1, according to an embodiment of the present invention; and

FIG. 12 is a graphical representation of a session screen of the system of FIG. 1, according to an embodiment of the present invention.

### DETAILED DESCRIPTION OF THE INVENTION

With reference to the drawings and in operation, the present invention provides a computer-based system 100 and method 200 for evaluating and correcting websites. The system 100 and method 200 are preferably embodied in a computer program running on a general purpose computer or workstation 102. Preferably, the computer 102 is connected to a network computer 104 or computers via a first network 106, such as the internet. The website or websites to be evaluated are located on the network computer 104. While the present invention is embodied in a piece of online software, it could be embodied in a stand alone piece of software, on a network, wide area network or any other suitable application.

Typically, the computer 102 includes a web crawler or spider 108 and is connected via the network 106 to the network computer 104 which includes a web server 110. The computer 102 communicates with the web server 110 over the network 106. In order to access a particular website, a user enters a web address or Uniform Resource Locator (URL) through a web browser 112 disposed in a user computer 105 connected to the computer 102 via the network 106.

The web crawler 108 communicates with the web server 110 and transmits a request thereto for the information located at the URL entered by the user. If located, the web server 110 sends the requested information to the web crawler 108. Generally, the information sent represents a blueprint of the website requested and includes code such as HTML, Java Script or any other suitable programming language. The blueprint describes what the text and graphics of the website will look like and their positions on the website.

The code includes key words which represent different functionalities and capabilities such as links, graphics and image pictures, text and interactive fields or any other suitable function. For example, a graphic image may be a separate file which is not immediately downloaded to the web crawler 108. The code may contain a link which points to the location of the graphic image on the web server 110. While interpreting the code, when the web crawler 108 may additionally request the graphic from the server 110.

The system 100 of the present invention executes a uniform process of diagnosis, reporting correction, and validation of source website code. The system 100 focuses on code has design errors and standards violations such as those that generate right-of-entry, navigation, and inhibitors. The system 100 removes standards violations in a rapid, reliable, consistent, and cost-effective manner. The potential payoff in terms of increased social equality, reduced legal liability, and controlled production expense is enormous.

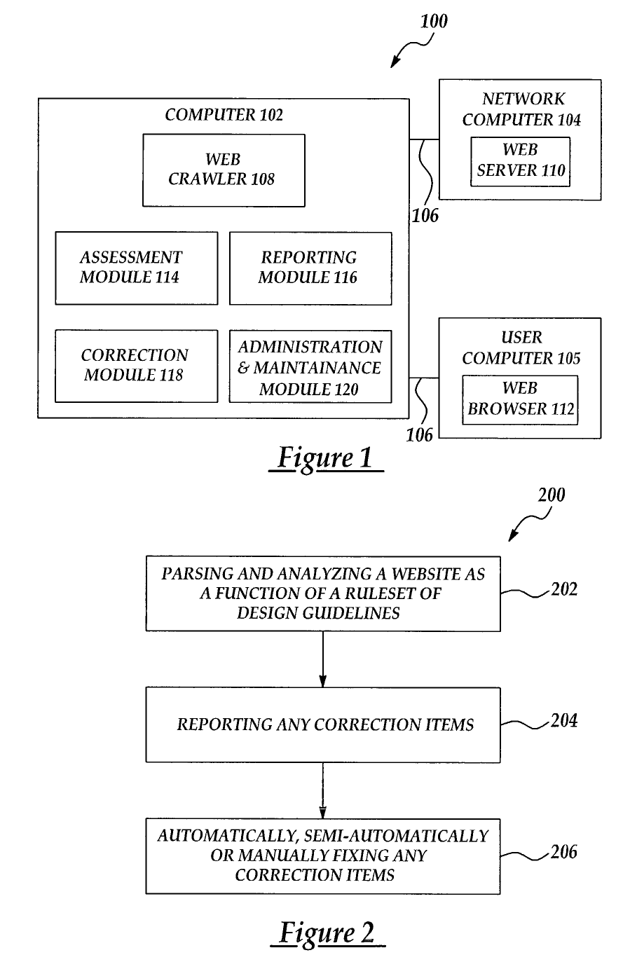

With specific reference to FIG. 1, the system: 100 includes an assessment module 114, a reporting module 116, a correction module 118 and an administration and maintenance module 120. In one embodiment, the web crawler 108, and the modules 114, 116, 118, 120 are embodied in software and the graphical user interface 112 is embodied in a web page.

The assessment module 114 identifies design errors and standards violations including syntax errors or the misuse of quotes, poor contrast, and missing HTML tags. The module 114 parses and analyzes the website as a function of a ruleset of design guidelines.

The parser is a tool for identifying the structure of the page so that rules can be written in terms of those structures. For example, the parser identifies an image tag having a particular form and a rule is generated which specifies that an image tag having an alternative form is required. The assessment module 114 continues to parse as issues are identified.

The ruleset of design guidelines is a detailed ruleset or list of rules derived from a thorough literature review, guideline analysis, user testing and experience, focus group interviews, and additional psychological principles. The ruleset of design guidelines comprises a set of standards. The standards may include government standards such as the Section 508 standard, a usability standard such as the W3C Web Content Accessibility Guidelines, a banking standard such as an FDIC standard, a branding standard, a telephone standard, a wireless website standard or any other suitable standard. Moreover, the ruleset is customizable to incorporate unique organizational standards such as internal style guides and branding guidelines. It is to be appreciated that a single standard or any combination of standards may be applied.

In addition, the standards include a set of rules for identifying higher-level properties of the sites, such as inferring where the primary navigation bar is or where the footer is, based on heuristics. These higher-level properties can then be used by other rules such as a rule specifying that the primary navigation bar should be visible in the first screen.

The assessment module 114 further includes a method of selecting the guidelines to apply, a technique for applying guidelines according to appropriate target users and target platforms, and a method for users to easily incorporate customized organizational guidelines to be discussed later.

The reporting module 116 is optimized for practical application of results in the site development process. The reporting module 116 performs the following functions: reporting of automatic correction items, semi-automatic assisted correction items, manual correction instruction items, ruleset justification, alternative correction options, and, ruleset conflict resolution rationale.

The correction module 118 includes components for functional site recoding, error correcting, and validation. The primary function of the correction module 118 is automated execution or semi-automated wizard-assisted implementation, and support for manual correction of reported ruleset violations. The system 100 further provides additional functionality including fixing minor alignment problems or font specifications, or adding ALT tags to images after querying the user for appropriate labels.

The administration and maintenance module 120 provides support for the storage, history, and long-term continuance of site updates. Principle attributes of the module 120 include providing documentation of changes made to the website via a file history and pedigree tool feature. The module 120 stores and retrieves website change documentation via a file archive tool feature, communicates with the web server 110 through the use of a file transfer tool feature, monitors and recommends website changes using a website auditing tool feature, and tracks website changes via a version control tool feature.

With specific reference to FIG. 2, the method 200 evaluates and corrects websites. In a first control block 202, the website is parsed and analyzed as a function of a ruleset of design guidelines. In a second control block 204, automatic correction items, semi-automated assisted correction items, and manual correction items are reported. In a third control block 206, the automatic correction items, semi-automated assisted correction items, and manual correction items are corrected.

The assessment module 114 applies the ruleset of design guidelines to the website located at the URL entered by the user. Functionally, the assessment module 114 methodically compares the website against the ruleset classification scheme to appraise how well the website relates to a baseline criteria.

For example, the guidelines are classified according to the several criteria, and their implementation can be prioritized accordingly. This classification also guides how correction item reports are organized and prioritized. The criteria may include, but are not limited to, the following: ease of problem identification, formal and informal compliance violations, complexity of the guideline, and impact of a repair on usability.

The guidelines may be classified according to how well a design problem can be automatically identified. While many correction items may be automatically identified and corrected, some items may only be identified as issues which the user should verify are in conformance with the guidelines. For example, while the absence of an HTML tag such as an ALT tag for images, is easily identified, it cannot be automatically corrected because the system 100 does not know what the ALT tag should be. However, applying the semi-automatic correction, the user is prompted to enter the pertinent information to allow the system 100 to replace the ALT tag. Moveover, effective perceptual relationships between content elements is extremely difficult to automatically evaluate, such as whether color is the sole indicator for distinguishing an element on the website. With regard to a manual correction item, the module 114 identifies color indicators and facilitates verification by prompting the user to verify that color is used correctly and provide documentation of such verification.

The guidelines may also be classified according to whether a design problem is a formal violation of a compliance issue, such as compliance to the W3C WAI guidelines (World Wide Web Consortium Web Accessibility Initiative).

The guidelines may further be classified according to whether a design guideline is clear-cut or involves complex tradeoffs including budgetary issues. An example of a clear-cut guideline is whether an ALT tag is missing. Tradeoffs may be major or minor. Such minor tradeoffs include whether or not a user should avoid italics at small font sizes. Major tradeoffs include designing for compatibility with the smallest screens or avoiding frames having a high degree of complexity.

Furthermore, the guidelines may be classified according to how much impact repairing a design problem will have on the quality of the final design. For example, the absence of a home button is a very serious navigation problem and text color and background color having low contrast is a very serious perceptual problem. Where body text is only ten point font size, this may be classifed as a moderate problem because it is too small for many readers and is considered primary content. However, where a copyright notice in a footer is only nine point font size, this is classified as a minor problem because the copyright text is not primary content.

The assessment module 114 includes a method of selecting rules to apply and a technique for applying guidelines according to appropriate target users and target platforms. The method includes the steps of initialization, start, stop, action, finish and fix.

Upon downloading a webpage, the initialization procedure initializes all rules in the ruleset to be applied to the website. For instance, during initialization all counters may be set to zero. The start procedure identifies that a piece of code may be a candidate match for a rule and starts buffering or recording. The stop procedure identifies when to stop buffering and calls the action procedure if the code segment matches a rule exactly. The action procedure records the violation and annotates the source. During the finish procedure, rules that apply across the entire webpage are detected, such as the presence of a title tag and labels for form fields. The finish procedure checks the status of each website rule, increments counters as a function of the ruleset, performs a final check of the website and determines whether there are overall page parameters to send back.

With regard to providing error attributes, the source code may be annotated through a technique whereby the code is tagged to assist and guide the automated evaluation. For example, two elements may be marked as having a specific semantic relationship so that the checker can report if the defined layout and design relationships are compatible with the semantic relationship.

In operation, as the webpage is loaded, the initialization procedure is called and as the code is parsed, tokens are passed to a rule matcher. When a match is made with the beginning of a rule template, that rule begins buffering the input and watches the input string for tokens that trigger a full match or a non-match. When a full match is made, the action procedure is triggered which typically adds an error marker to the input stream to tag the source code and adds an error to the error table. The error table is used to generate the primary report of problems found. When parsing the page finishes, the finish procedure is executed.

The reporting module 116 identifies which items can be corrected automatically including items which the system 100 can correct without administrative assistance, including items which the system 100 can semi-automatically correct with minimal administrative assistance, and including items which the system 100 can not correct and require manual correction from a user, such as a site administrator.

The reporting module 116 also provides several secondary assessment reports including: ruleset justification, alternative correction options, and conflict resolution. The ruleset justification report provides reference information for a site administrator to understand rule violations. The alternative correction report provides information to the site administrator when multiple options to correct code violations exist. The conflict resolution report provides detailed information for the site administrator to understand causal triggers and the logical basis of recognized rule violations.

In addition, the module 116 generates reports specific to target demographics. Such reports provide information relevant to the target audience and target platform and identify problems specific to the targeted audience. For example, the reports including specific guidelines for an international or local target audience, specific guidelines for sites targeted at children, and checking a site for compliance to specific screen sizes or browser versions may be generated.

Furthermore, the module 116 generates reports that evaluate the site design for specific tasks. Such tasks provide task descriptions to check effective implementation of those tasks and critique those task designs.

The report module 116 generates reports listing all errors and items detected. Such reports enable the administrator to determine the level of compliance of a site, such as the accessibility of the website and that any links present on the website are valid and have not been broken. The items and errors that are listed may be reported non-linearly, linearly, or in any other suitable manner. Non-linear reports enable a user to view the items and errors in any order, thereby permitting the user to navigate between standards, rules, or any other desired manner to perform fixes, documentation or take any other necessary measures. The process of non-linear viewing of the reports enables the administrator to address the items and errors according to priorities set by the administrator as a function of budget, time constraints, or customer demand.

The correction module 118 provides an escalating feature set of functions to fix violations of the ruleset. There are three basic types of remedies: automatic, semi-automatic, and manual. Once the correction tool has been applied to a site, a new version of the site files is generated with the problems rectified. This site may be served as the primary or secondary code for the site. The correction tool may be may be network-based or on a stand-alone system. If the tool is network based, the most current version of available guidelines may be used. On a stand-alone system, the guidelines must be continuously upgraded.

As changes are made and several versions of the code are generated, the administration module allows the administrator to track the changes made such that the administrator may retract a more current version and revert back to an earlier version.

Items identified as automatically correctable are presented as an itemized checklist. The site administrator has the option to opt out of fixing these rules violations. Once executed, the tool will, without further user input, remedy the items reported.

Items identified as semi-automatically correctable are presented as an itemized checklist. The site administrator has the option to opt out of fixing these rules violations. Items selected for correction are presented to the site administrator with prompts and methods to resolve conflicts or violations in the fashion of a wizard.

Items identified as manually correctable are presented as an itemized list. The site administrator is presented with alternative solutions to resolve the violation. The administrator will manually recode site files. This feature set is necessary for a wide variety of complex design problems that may not be automatically correctable. However, it is still useful to support the manual correction process by itemizing and categorizing the errors, prompting the need for correction, providing documentation to assist in manual correction, and facilitating record-keeping of corrections that are made.

The administration and maintenance module 120 contains components to support the storage, history, and long-term support of the website. The module 120 includes file history and pedigree tool features, file archive tool features, file transfer and upload tool features, and monitoring and subscription tool features.

The file history and pedigree tool features document the history of site files such as when changes were made, the types of changes made, and the administrator responsible for making the change or changes. Where the administrator chooses to ignore an error listed in a report, perhaps because it is not required by law and would be costly or time-consuming to fix, such reasons may be documented, thereby removing the error status associated with the item. The file archive tool features store and retrieve site change documentation. The file transfer and upload tool features communicate with servers for transfer and upload of site files. The monitoring and subscription tool features provide the ability to monitor the site files over time to enable monitoring of changes and initiate change recommendation.

Furthermore, the reports created, including documentation specifying how each correction item was resolved, may be summarized and retrieved in a compliance report at the culmination of the correction process in a long report or throughout the correction process in several short reports.

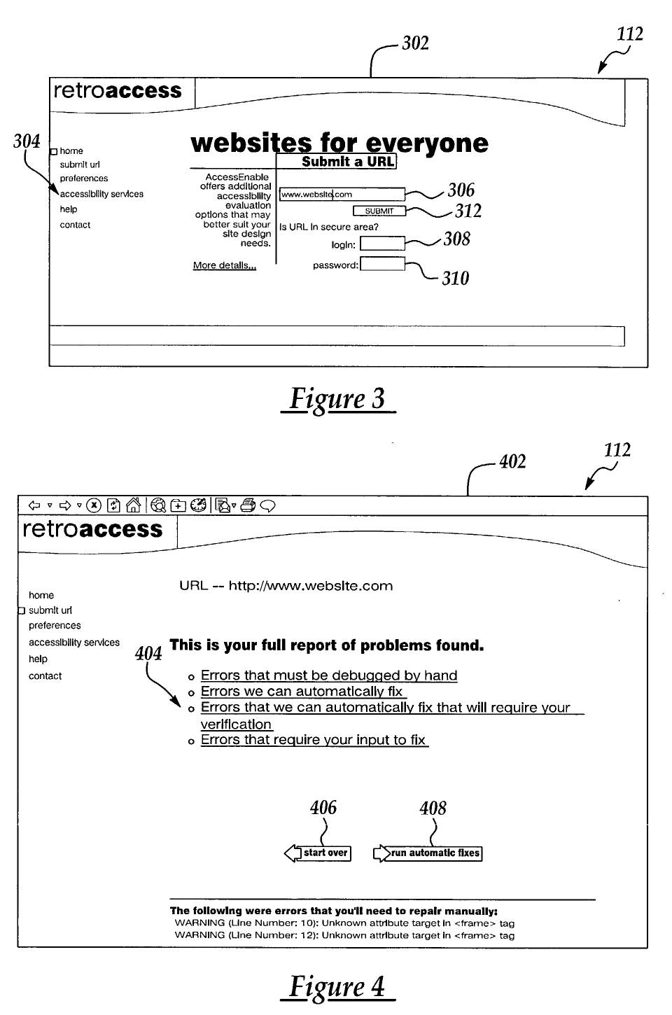

With reference to FIGS. 3 through 13, the system 100 includes the graphical user interface (GUI) 112. In one embodiment, access to the system 100 is provided over the internet and the graphical user interface 112 is embodied in a web page accessed via a web browser 108.

Furthermore, the system of the present invention evaluates and corrects dynamically generated web pages, which are generated real-time as a function of input from the user.

With specific reference to FIG. 3, the GUI 112 includes an initial screen 302. The initial screen 302 includes a list of menu items 304 for navigating the system 100. The initial screen 302 includes a URL input text box 306, a login text box 308, a password textbox 310, and a submit button 312. It is to be appreciated that the initial screen 302 may include the URL input text box 306 and menu items 314 wherein the user may select one or more pages of the website to be evaluated.

A user of the system 100 simply types in the target website in the URL input text box 306 and selects the submit button 312. The login text box 308 and the password textbox 310 are optional and are used if the target website requires a user id and password for access.

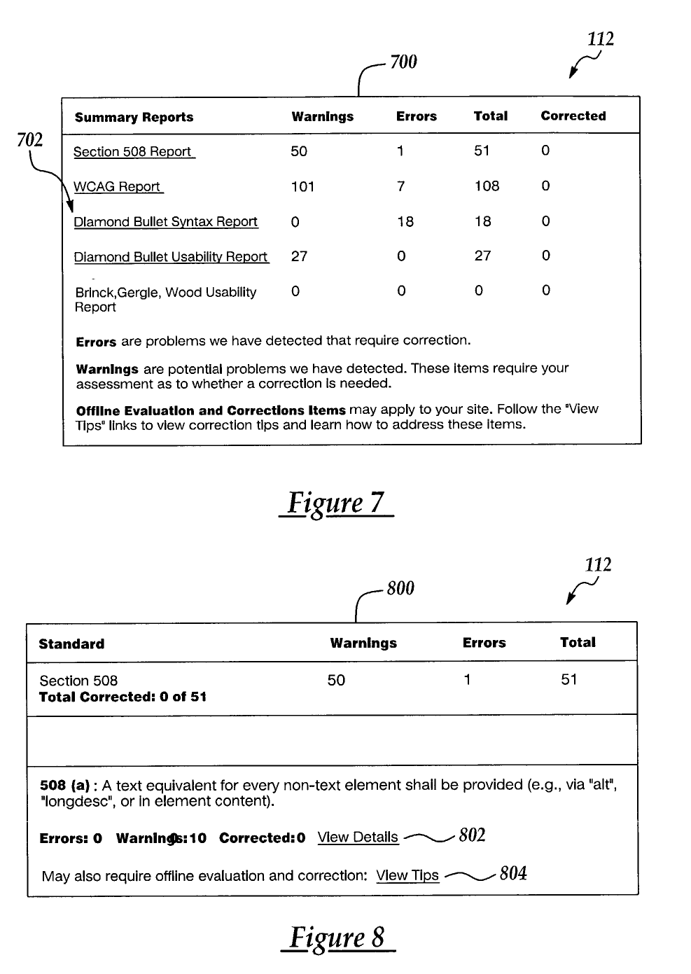

With specific reference to FIGS. 6 and 7, after the submit button 312 has been selected, a progress screen 600 is displayed to display the progress of the website verification. The progress is updated automatically. However, the progress screen includes a refresh link 602 which allows the user to manually update the progress screen

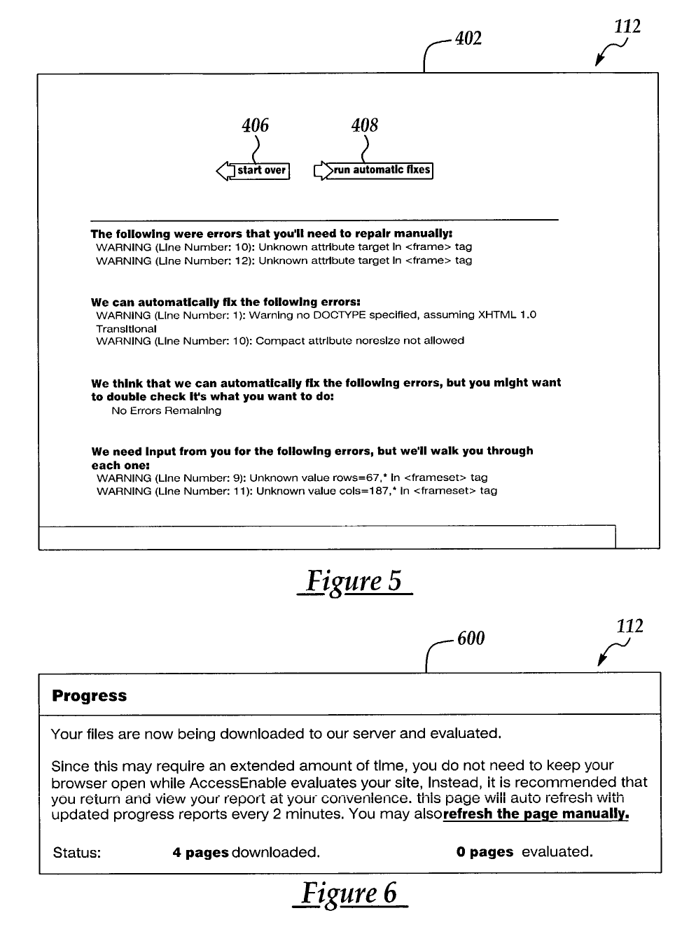

With specific reference to FIG. 4, once the website verification is complete, a reporting screen 402 is displayed. The reporting screen 402 includes a list of links 404 identifying the types of errors found in the target website. As shown in FIG. 5, below the list of links 404, the errors are listed in separate sections based on type. Selection of one of the links 404 displays the appropriate list. Alternatively, the report screen 402 can be scrolled down to display the list 404.

The reporting screen 402 includes a Start Over Button 406 and a Run Automatic Fixes Button 408. Selection of the Start Over Button 406 returns the GUI 112 to the initial screen 302. When the Run Automatic Fixes Button 408 is selected, the system 100 automatically fixes that errors that can be fixed automatically.

With reference to FIG. 7, the GUI 112 displays a summary reports screen 700 including a listing of report links 702 which allow the user to select the report generated according to each standard under which the website was evaluated. The summary reports screen 700 also provides a summary of the number of warnings and errors detected and corrections made.

With reference to FIGS. 8 through 11, once the user selects a report link 702 from the summary reports screen 700, a standard screen 800 is displayed. The standard screen 800 includes a details link 802 and a tips link 804. The links 802, 804 allow the user to view the errors and warnings detected, view the tips for verifying manual or semi-automatic correction items, and view the corrections or justifications made.

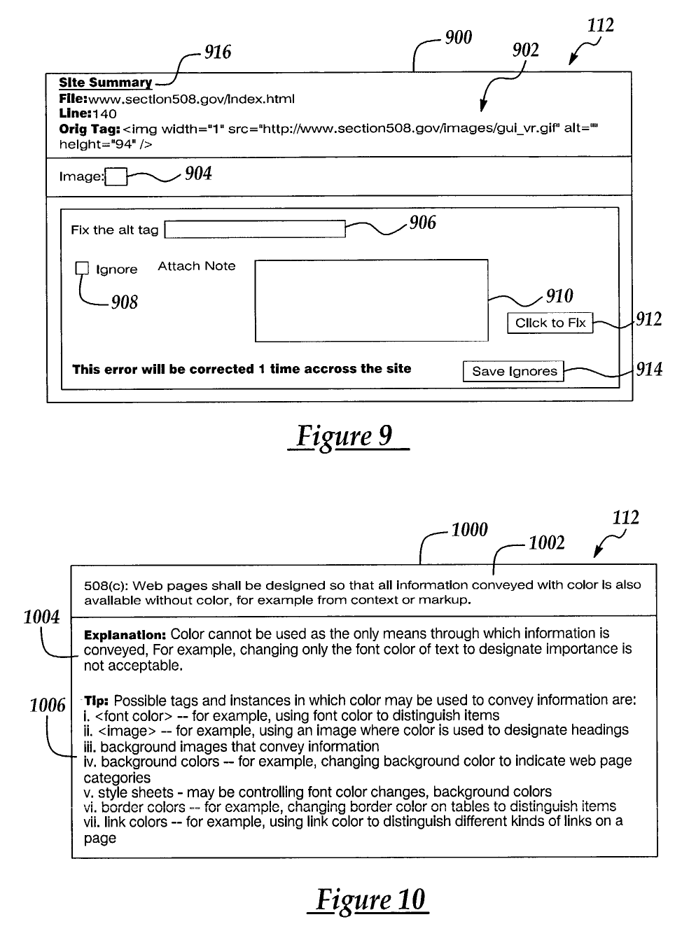

With specific reference to FIG. 9, selecting the details link 802 displays a correction screen 900 having header information 902 denoting the file, the standard and the location in the original code where the error occurred. The correction screen 900 includes an error text box 904 describing the particular error detected, such as an image tag error. A fix input text box 906 allows the user to provide input for semi-automatic correction items. For example, where an image is missing an ALT tag, as discussed above, the user is prompted to enter the appropriate information associated with the ALT tag. The correction screen 900 further includes an ignore input box 908 and a note input text box 910. The ignore input box 908 enables the user to choose to ignore a particular error and document the rationale for doing so.

The correction screen 900 includes a Fix button 912 and a Save Ignores button 914. Once the Fix button 912 is selected, the code is corrected. Upon selecting the Save Ignores button 914, the appropriate information is saved in the code and the documentation.

With reference to FIG. 10, selecting the tips link 804 at the standard screen 800 displays a tips screen 1000 having rule information 1002 as a function of the standard applied to the website with a rule explanation 1004 explaining the rule information 1002. The tips screen 1000 includes a tip list 1006 listing the possible locations in the code wherein the tip may apply, thereby directing the user to an area of the code requiring manual correction.

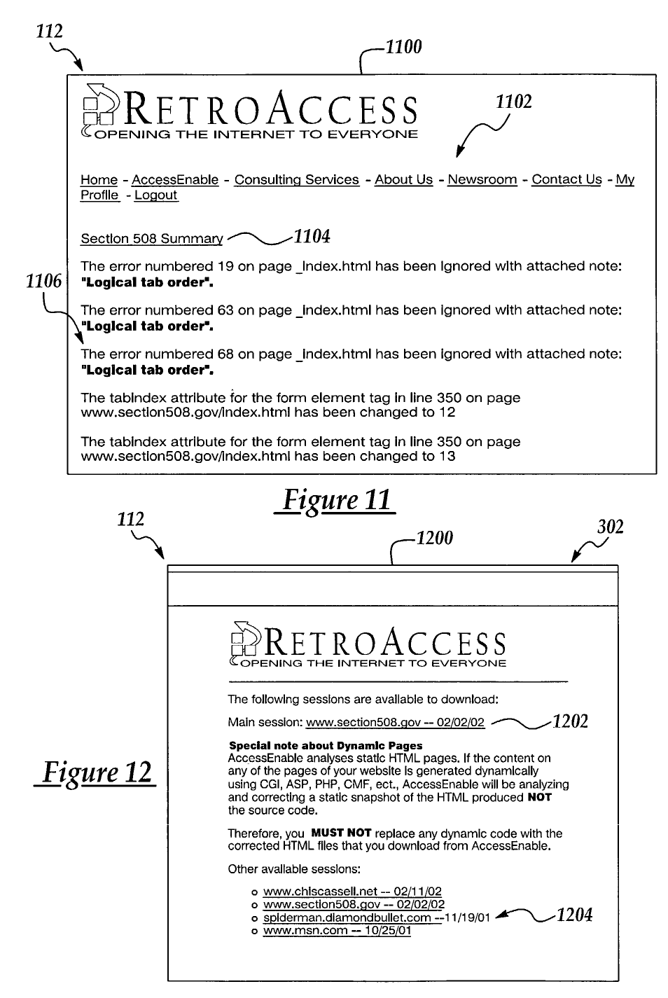

With reference to FIGS. 9 and 11, the user selects a site summary link 916 to access a correction summary screen 1100 including site links 1102 which provide links to various locations on the website, a report link 1104 allowing the user to return to the summary report screen 700, and a corrections list 1106. The corrections list 106 includes a summary of the correction items addressed automatically, semi-automatically or manually and the status of the correction.

With reference to FIG. 12, the initial screen 312 further includes a session screen 1200. The session screen 1200 includes a first session link 1202 listing the websites undergoing evaluation and a second session link 1204 listing those which have already been evaluated. The user may select a website from the first or second session link 1202, 1204 and view the progress of the evaluation or the reports available as a result of the evaluation.

The invention has been described in an illustrative manner, and it is to be understood that the terminology that has been used is intended to be in the nature of words of description rather than limitation. It will be apparent to those skilled in the art that many modifications and variations of the present invention are possible in light of the above teachings. Therefore, it is to be understood that the invention may be practiced otherwise than as specifically described within the scope of the amended claims.

What is claimed is:

1. A computer system for evaluating and correcting a website, the system comprising:
an assessment module disposed in said computer system and being adapted to parse and analyze the website as a function of a ruleset of design guidelines;
a reporting module disposed in said computer system and being adapted to report at least one correction item, the at least one correction item being one of an automatic correction item, a semi-automated assisted correction item, and a manual correction item; and
a correction module disposed in said computer system and being adapted to correct the at least one correction item.

2. A computer system, as set forth in claim 1, including an administration and maintenance module disposed in said computer system and being adapted to support storage, history, and long-term continuance of website updates.

3. A computer system, as set forth in claim 1, including a network computer connected to the computer system via a network, wherein the website is stored on the network computer.

4. A computer system, as set forth in claim 3, including a user computer connected to the computer system via the network, wherein user computer includes a web browser for displaying the website.

5. A computer system, as set forth in claim 4, wherein the network is the internet.

6. A computer system, as set forth in claim 1, including a web crawler module disposed in the computer system and adapted to request, receive and interpret the website.

7. A computer system, as set forth in claim 6, wherein the network computer includes a web server module for downloading the website to the web crawler module.

8. A computer system, as set forth in claim 1, wherein the computer system includes a documentation module for documenting the correction items.

9. A computer system, as set forth in claim 8, wherein the modules are embodied in software.

10. A computer system, as set forth in claim 8, wherein the website is embodied in software.

11. A computer system, as set forth in claim 1, wherein the ruleset of design guidelines includes a government standard.

12. A computer system, as set forth in claim 11, wherein the government standard is a Section 508 standard.

13. A computer system, as set forth in claim 1, wherein the ruleset of design guidelines includes an accessibility standard.

14. A computer system, as set forth in claim 13, wherein the design standard is a World Wide Web Consortium design standard.

15. A computer system, as set forth in claim 1, wherein the ruleset of design guidelines includes a banking standard.

16. A computer system, as set forth in claim 15, wherein the banking standard is an FDIC standard.

17. A computer system, as set forth in claim 1, wherein the ruleset of design guidelines includes a branding standard.

18. A computer system, as set forth in claim 1, wherein the ruleset of design guidelines includes an in-house style guide.

19. A computer system, as set forth in claim 1, wherein the ruleset of design guidelines includes a telephone standard.

20. A computer system, as set forth in claim 19, wherein the telephone standard includes a wireless website standard.

21. A computer system, as set forth in claim 1, wherein the reporting module is adapted to report a plurality of correction items non-linearly.

22. A computer system, as set forth in claim 1, wherein the reporting module is adapted to provide ruleset justification.

23. A computer system, as set forth in claim 1, wherein the reporting module is adapted to provide alternative correction options.

24. A computer system, as set forth in claim 1, wherein the reporting module is adapted to provide ruleset conflict resolution rationale.

25. A computer system, as set forth in claim 1, wherein the correction module is adapted to provide functional site recoding.

26. A computer system, as set forth in claim 1, wherein the correction module is adapted to provide error correction.

27. A computer system, as set forth in claim 1, wherein the correction module is adapted to ignore the at least one correction item.

28. A computer system, as set forth in claim 27, wherein the correction module is adapted to document rationale for ignoring the at least one correction item.

29. A computer system, as set forth in claim 1, wherein the correction module is adapted to provide validation.

30. A computer system, as set forth in claim 2, wherein the administration and maintenance module is adapted to provide documentation of website changes.

31. A computer system, as set forth in claim 2, wherein the administration and maintenance module is adapted to store website change documentation.

32. A computer system, as set forth in claim 2, wherein the administration and maintenance module is adapted to retrieve website change documentation.

33. A computer system, as set forth in claim 2, wherein the administration and maintenance module is adapted to communicate with a server.

34. A computer system, as set forth in claim 2, wherein the administration and maintenance module is adapted to monitor website changes.

35. A computer system, as set forth in claim 2, wherein the administration and maintenance module is adapted to recommend website changes.

36. A computer system, as set forth in claim 2, wherein the administration and maintenance module is adapted to track website changes.

37. A computer system for evaluating and correcting a website, the system comprising:
an assessment module disposed in the computer system being adapted to parse and analyze the website as a function of a ruleset of design guidelines;
a reporting module disposed in the computer system and adapted to report at least one correction item, the at least one correction item being one of an automatic correction item, a semi-automated assisted correction item, and a manual correction item;
a correction module disposed in the computer system and adapted to correct the at least one correction item;
an administration and maintenance module disposed in the computer system and being adapted to support storage, history, and long-term continuance of website updates;
a network computer connected to the computer system via a network, wherein the the website is stored on the network computer;
a web crawler module disposed in the computer system and adapted to request, receive and interpret the website; and
a web server module connected to the computer system for downloading the website to the web crawler module.

38. A method for evaluating and correcting a website including the steps of:
parsing and analyzing the website as a function of a ruleset of design guidelines;
reporting at least one correction item, the at least one correction item being one of an automatic correction item, a semi-automated assisted correction item, and a manual correction item; and,
correcting the at least one correction item.

39. A method, as set forth in claim 38, including the step of initializing the webpage as a function of the ruleset.

40. A method, as set forth in claim 38, including the step of identifying a rule match as a function of the ruleset.

41. A method, as set forth in claim 38, the step of including buffering the website as a function of the ruleset.

42. A method, as set forth in claim 38, including the step of tagging the website as a function of a ruleset.

43. A method, as set forth in claim 38, including the step of finalizing the analysis of the webpage as a function of the ruleset.

44. A method, as set forth in claim 38, including the step of providing support for storage, history, and long-term continuance of website updates.

45. A method, as set forth in claim 38, including the step of connecting a network computer to the computer system via a network, wherein the network computer includes the website to be evaluated.

46. A method, as set forth in claim 45, including the step of requesting, receiving and interpreting the website.

47. A method, as set forth in claim 46, including the step of downloading the website.

48. A method, as set forth in claim 47, including the step of documenting the correction items.

49. A method, as set forth in claim 38, including the step of reporting the items non-linearly.

50. A method, as set forth in claim 38, including the step of providing ruleset justification.

51. A method, as set forth in claim 38, including the step of providing alternative correction options.

52. A method, as set forth in claim 38, including the step of providing ruleset conflict resolution rationale.

53. A method, as set forth in claim 38, including the step of providing functional site recoding.

54. A method, as set forth in claim 38, including the step of providing error correction.

55. A method, as set forth in claim 54, including the step of validating error corrections.

56. A method, as set forth in claim 38, including the step of providing file history and pedigree.

57. A method, as set forth in claim 38, including the step of tracking website changes.

58. A method, as set forth in claim 38, including the step of archiving files.

59. A method, as set forth in claim 38, including the step of providing communication with a server.

60. A method, as set forth in claim 38, including the step of transferring files.

61. A method, as set forth in claim 38, including the step of monitoring website changes.

62. A method, as set forth in claim 38, including the step of recommending website changes.

63. A method for evaluating and correcting a website, comprising the steps of:
parsing and analyzing the website as a function of a ruleset of design guidelines;
reporting at least one correction item, the at least one correction item being one of an automatic correction item, semi-automated assisted correction item, and manual correction item;
correcting the at least one correction item;
providing support for storage, history, and long-term continuance of website updates;
connecting a network computer to the computer system via a network, wherein the network computer includes the website to be evaluated;
requesting, receiving and interpreting the website; and
downloading the website.
